(19) United States
(12) Patent Application Publication
(10) Pub. No.: US 2017/0146148 A1
(43) Pub. Date: May 25, 2017

(54) PNEUMATIC VALVE FOR VEHICLE

(71) Applicants: HYUNDAI DYMOS INCORPORATED, Seonsan-si (KR); INZICONTROLS CO., LTD, Siheung-si (KR)

(72) Inventors: Dong Gi KIM, Osan-si (KR); In Ho LEE, Hwaseong-si (KR); Sin Jeong KANG, Hwaseong-si (KR); Sung Hoon KIM, Seoul (KR); Jong Dae IM, Ansan-si (KR); Taek Seung KIM, Seoul (KR); Kwang Bok PARK, Siheung-si (KR); Jeong Dae KIM, Incheon (KR); Hyo Yeol SON, Incheon (KR)

(73) Assignees: HYUNDAI DYMOS INCORPORATED, Seosan-si (KR); INZICONTROLS CO., LTD, Siheung-si (KR)

(21) Appl. No.: 15/354,764

(22) Filed: Nov. 17, 2016

(30) Foreign Application Priority Data
Nov. 19, 2015 (KR) 10-2015-0162519

(51) Int. Cl. F16K 31/06

(52) U.S. Cl. CPC F16K 31/0658

(57) ABSTRACT

The present disclosure relates to a pneumatic valve for a vehicle. The pneumatic valve includes: a valve housing having a channel for air to flow therein and having a first end where an exhaust port communicating with the channel and an exhaust nipple are formed; a core fixed to a second end of the valve housing and sending air flowing inside from outside to the channel; a check valve disposed at a first end of the core, passing air flowing to the channel from the outside through the core, and blocking air flowing to the outside from the channel through the core; a plunger disposed to face the first end of the core and moving through the channel; and a sealing member disposed at a first end of the plunger and opening or closing the exhaust port by moving with the plunger.

### CROSS-REFERENCE TO RELATED APPLICATION

This application claims priority to and the benefit of Korean Patent Application No. 10-2015-0162519, filed on Nov. 19, 2015, which is incorporated by reference in its entirety.

### FIELD

The preset present disclosure relates to a pneumatic valve for a vehicle.

### BACKGROUND

The statements in this section merely provide background information related to the present disclosure and may not constitute prior art.

Recently, the demand for a pneumatic apparatus that can control various parts is increased.

In the related art, 1) there was a problem with size and weight due to separate assembly of an intake/exhaust structure and addition of a connection structure when a unidirectional separable actuator is applied, and 2) it was difficult to control air leakage and provide pressure in an intake/exhaust connection structure that is an intake-intake actuator assembly/exhaust-exhaust actuator assembly structure when expanding a valve.

In order to address these problems, the applicant(s) has filed application, which was issued as Korean Patent No. 10-1553528, of a pneumatic valve having a structure that can achieve intake/exhaust of air with one actuator by making the actuator in an integrated bidirectional structure and can maintain uniform flow of air by continuously forming an intake port of air.

However, the present disclosure in the patent document also uses two actuators for intake and exhaust.

Further, according to an intake/exhaust control valve using one actuator known in the art, an actuator and a check valve are separated, so a T-shaped structure is formed, and accordingly, packaging is difficult and there is a limit in reducing the size.

The description provided above as a related art of the present disclosure is only for helping understanding the background of the present disclosure and should not be construed as being included in the related art known by those skilled in the art.

### SUMMARY

The present disclosure provides a pneumatic valve for a vehicle that can reduce the number of parts, particularly actuators and simplify the entire structure into an I-shape.

According to an aspect of the present disclosure, a pneumatic valve for a vehicle includes: a valve housing having a channel for air to flow therein and having a first end where an exhaust port communicating with the channel and an exhaust nipple are formed; a core fixed to a second end of the valve housing and configured to send air flowing inside from outside to the channel; a check valve disposed at a first end of the core and configured to pass air flowing to the channel from the outside through the core, the check valve configured to block air flowing to the outside from the channel through the core; a plunger disposed to face the first end of the core and to move through the channel; and a sealing member disposed at a first end of the plunger and configured to open or close the exhaust port by moving with the plunger.

The pneumatic valve may further include a coil disposed outside the valve housing and configured to slide the plunger using an electromagnetic force when power is supplied.

The pneumatic valve may further include an elastic member disposed between the plunger and the core. The pneumatic valve may be a normal close type in which the plunger is pressed to the first end of the valve housing by the elastic member, such that the sealing member keeps the exhaust port closed.

When air with a predetermined pressure is supplied to a second end of the core and power is not supplied to the coil, the check valve may be opened, air may flow into the channel, the plunger may be pressed to the first end of the valve housing by the elastic member, and the sealing member may keep the exhaust port closed, such that the air flowing in the channel may be discharged to the outside through the exhaust nipple.

The exhaust nipple may be connected to an external air storage unit, and when air is not supplied to the second end of the core and power is not supplied to the coil, the check valve may be blocked by the pressure of the air in the air storage unit, airflow to the outside through the core from the channel may be blocked, the plunger may be pressed to the first end of the valve housing by the elastic member, and the sealing member may keep the exhaust port closed, so the air in the air storage unit may be kept therein.

The exhaust nipple may be connected to an external air storage unit, and when air is not supplied to the second end of the core and power is supplied to the coil, the plunger may be slid to the coil by an electromagnetic force generated by the coil and the sealing member may open the exhaust port, so the air in the air storage unit may be discharged through the exhaust port.

The core may have: a coupling part disposed in the valve housing in contact with the inner side of the valve housing; and an intake nipple exposed toward the second end of the valve housing and connected to an air supply unit configured to supply air from the outside.

A protrusion inclined upward toward the second end of the valve housing may be formed around the coupling part and a groove having a shape corresponding to the shape of the coupling part may be formed around the inner side of the valve housing to receive the protrusion. The groove is in contact with the coupling part.

According to another aspect of the present disclosure, a pneumatic valve for a vehicle includes: a valve housing having a channel for air to flow therein and having a first end where an exhaust port configured to communicate with the channel and an exhaust nipple are formed; a core fixed to a second end of the valve housing and configured to send air flowing inside from the outside to the channel; a check valve disposed at a first end of the core and configured to pass air flowing to the channel from the outside through the core, the check valve configured to block air flowing to the outside from the channel through the core; a plunger disposed to face the first end of the core and configured to move through the channel; an elastic member disposed between the plunger and the core and configured to press the plunger to the first end of the valve housing; a coil disposed outside the valve housing and configured to slide the plunger using an electromagnetic force when power is supplied; and a sealing member disposed at a first end of the plunger and configured to open or close the exhaust port by moving with the plunger, in which when power is not supplied to the coil, the plunger is pressed to the first end of the valve housing by the elastic member and the sealing member keeps the exhaust port closed, and when power is supplied to the coil, the plunger slides to the coil and the sealing member opens the exhaust port, such that the exhaust port and the exhaust nipple communicate with each other through the channel.

According to the pneumatic valve for a vehicle, it is possible to achieve intake/exhaust using one actuator, so it reduces the number of controllers for controlling the valve and simplifies a control algorism.

Further, the pneumatic valve reduces the number and weight of parts for achieving the pneumatic valve for a vehicle and also may reduce the size of the valve so that manufacturing cost can be reduced.

In particular, the present disclosure may reduce the manufacturing cost by removing a sealing member and also secure the ability to operate an actuator of a solenoid valve by increasing the area where a magnetic force can be secured.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view showing a pneumatic valve for a vehicle;

FIGS. 2 to 4 are views showing the operation of the pneumatic valve for a vehicle; and

FIG. 5 is an enlarged view of the portion indicated by ‘A’ in FIG. 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Pneumatic valves for a vehicle according to various forms of the present disclosure are described hereafter with reference to the accompanying drawings.

Control devices that can support the waist/sides/buttocks of passengers using a pneumatic system are used in automotive seats. A pneumatic valve for a vehicle according to one form of the present disclosure has a simple I-shaped structure using only one actuator for intake/exhaust and can be applied to automotive pneumatic control systems to be described below. For example, the pneumatic valve can be applied to a lumbar support (waist support), a bolster control device (sides/thighs), a cushion control device (buttocks/thighs), and a massage system (relax for entire body) etc.

According to one form, a sealing member at the lower end of a plunger keeps an exhaust port closed using an elastic member such as a spring while power is not applied to a coil. Further, according to another form, an exhaust port is opened by sliding a plunger to a core only while power is supplied to a coil, so an air bladder keeps air to communicate with the exhaust port, whereby the air is naturally discharged by the pressure from the bladder.

As described above, a pneumatic valve for a vehicle can achieve intake and exhaust using only one actuator, so it is possible to simplify and share main parts and reduce the number of the main parts, as compared with the related art, whereby it is possible to decrease the weight, size, and manufacturing cost.

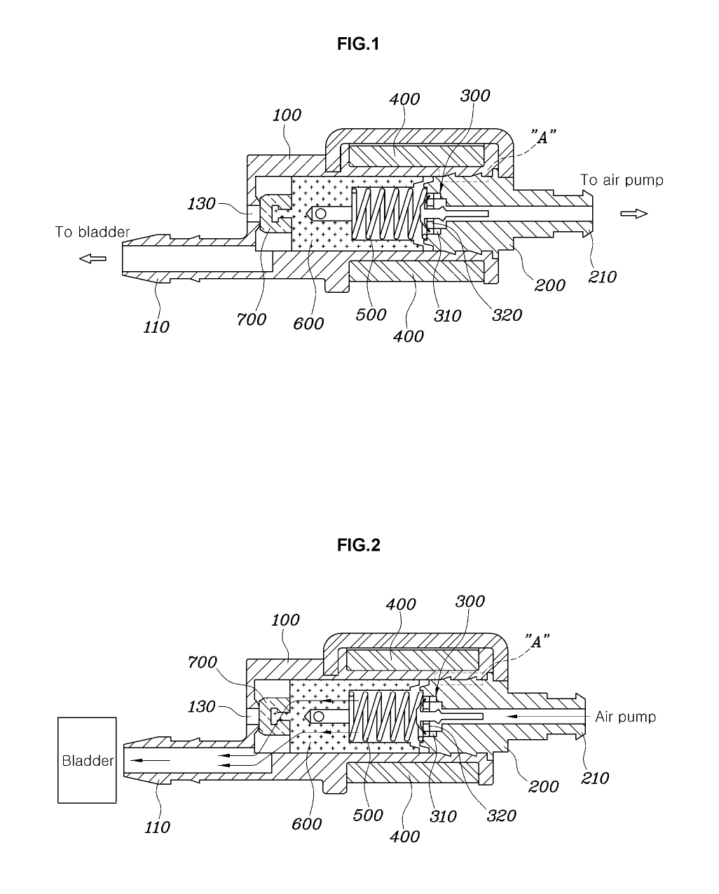

FIG. 1 is a view showing a pneumatic valve for a vehicle according to one form of the present disclosure.

As shown in FIG. 1, a pneumatic valve for a vehicle may include: a valve housing 100, a core 200, a check valve 300, a plunger 600, and a sealing member 700. The pneumatic valve for a vehicle may further include a coil 400 and an elastic member 500.

The valve housing 100 has two ends and a channel that is an internal space through which air flows.

An exhaust nipple 110 and an exhaust port 130 may be formed at a first end (left side in the figure) of the valve housing 100. The exhaust nipple 110 is a passage for sending air flowing in the valve housing 100 through the core 200 back into an external air storage unit. When the valve is applied to an automotive seat, the exhaust nipple 110 may be connected to an air bladder (not shown). That is, as the exhaust nipple 110 is connected to the air bladder, it is possible to fill the air bladder with air by supplying air to it. Further, when the plunger 600 is moved to the core 200 and the exhaust port 130 is opened, the exhaust nipple 110 connected to the air bladder communicates with the exhaust port 130, so the air in the air bladder can be discharged.

An open channel may be formed at a second end (right side in the figure) of the valve housing 100 to couple the core 200.

The core 200 is coupled to the second end of the valve housing 100. The core 200 has a channel therein for air to flow, so external air can be supplied into the channel in the valve housing 100.

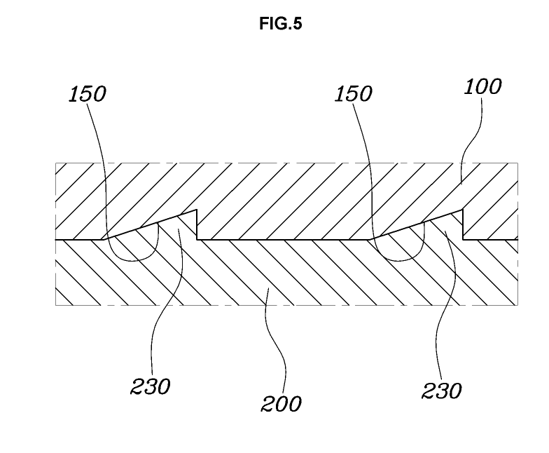

The core 200 may include a coupling part that is coupled in the valve housing 100 and an intake nipple 210 that is exposed outside from the second end of the valve housing 100 and connected to a component for supplying air (for example, an air pump). The area, which is in contact with the inner side of the valve housing 100, of the coupling part is indicated by ‘A’ in FIG. 1. The contact area of the coupling part will be described in detail below with reference to FIG. 5.

The check valve 300 is disposed at a first end (opposite to the intake nipple) of the core 200. The check valve 300 is a valve allowing for only one-directional flow of fluid, and in one form, when air is supplied at a predetermined pressure to the intake nipple 210 of the core 200 by an air pump etc., the check valve 300 is opened by the pressure of the air and the air flows into the channel in the valve housing 100 through the core 200.

Further, when the pressure in the channel in the valve housing 100 is high, the check valve 300 is closed and air cannot flow from the channel in the valve housing 100 to the core 200. A sealing rubber 310 and a washer 320 may be provided to hermetically and mechanically combine the check valve 300.

The check valve 300 is well known in the art, so the structure or operation is not described in detail herein.

The plunger 600 can slid through the channel in the valve housing 100. The plunger 600, which is a component of an actuator, can slide to operate the actuator when power is supplied to the coil 400. In particular, in one form, the plunger 600 moves to the core 200 only when it is operated as an actuator. More specifically, when power is supplied to the coil 400 to operate an actuator for a solenoid valve, the plunger 600 can move to the core 200 by an electromagnetic field induced around the coil 400.

When the plunger 600 is not operated as an actuator, that is, when power is not supplied to the coil 400, the plunger 600 is maintained at the closest position to the first end of the valve housing 100. To this end, the elastic member 500, for example, a spring 500 may be disposed between the plunger 600 and the core 200.

The spring 500 may be positioned to be able to provide force acting in both directions between the fixed core 200 and the plunger 600 moved closest to the first end of the valve housing 100. Accordingly, the plunger 600 is maintained at the position after sliding to the first end of the valve housing 100 by the spring 500 when power is not supplied to the coil 400.

The sealing member 700 is disposed at a second end (left side in the figure) of the plunger 600. The sealing member 700 is fixed to the second end of the plunger 600, so it can slide with the plunger 600.

The sealing member 700 is a component for opening/closing the exhaust port 130 at the first end of the valve housing 100. That is, when the plunger 600 slide to the first end of the valve housing 100, the sealing member 700 closes the exhaust port 130, but when the plunger 600 slides to the core 200, the sealing member 700 opens the exhaust port 130.

In order to hermetically close the exhaust port 130 with the sealing member 700, the sealing member 700 may be made of a material having a predetermined level of elasticity such as rubber.

As described above, since the plunger 600 having slid to the first end of the valve housing 100 is maintained at the position by the spring 500 when power is not supplied to the coil 400, the pneumatic valve for a vehicle is a normal close type valve.

The pneumatic valve for a vehicle having the configuration described above may operate as follows.

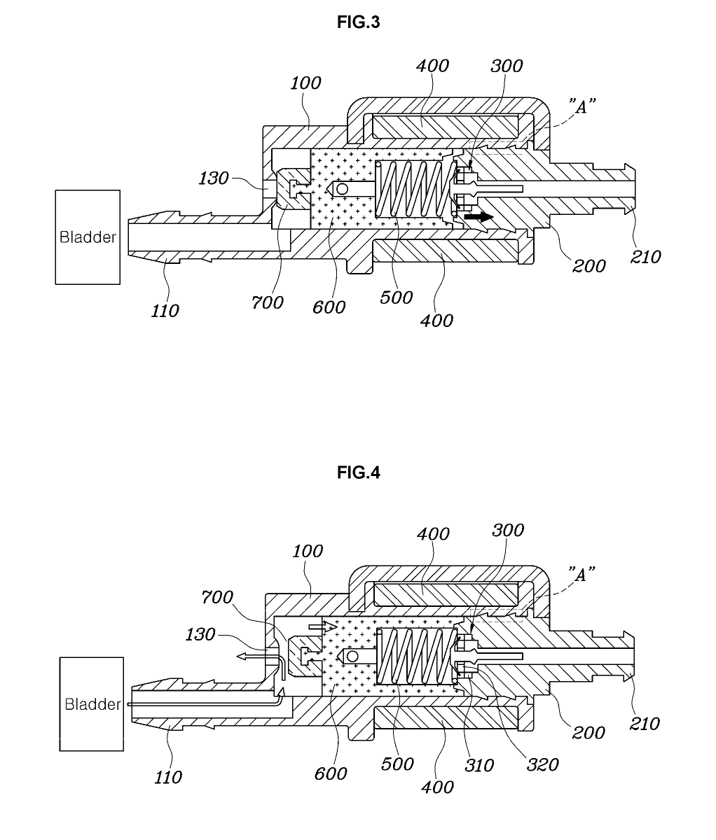

FIGS. 2 to 4 are views showing the operation of the pneumatic valve for a vehicle according to one form of the present disclosure.

In particular, FIG. 2 shows a state when air is supplied at a predetermined pressure through the intake nipple 210 of the core 200 from an air pump etc. As shown in FIG. 2, when air at a predetermined pressure is supplied into the intake nipple 210 of the core 200, the check valve 300 at the first end of the core 200 is moved by a predetermined distance to the first end (left side in the figure) of the valve housing 100 by the pressure of the air, so the air flows into the channel in the valve housing 100 through the core 200.

When power is not still supplied to the coil 400 not to operate an actuator of a solenoid valve, the plunger 600 having slid to the first end of the valve housing 100 is maintained at the position by the spring 500, so the sealing member 700 keeps closing the exhaust port 130.

Accordingly, the air flowing inside through the core 200 can be supplied into an air storage unit (for example, an air bladder) through the exhaust nipple 110 connected to the air storage unit.

FIG. 3 shows a state when a desired amount of air is supplied to an air storage unit (air bladder), so an air pump is stopped and the air bladder keeps the air.

As shown in FIG. 3, when power is not supplied to the coil 400 and air supply to the intake nipple 210 of the core 200 is stopped, the check valve 300 is moved by a predetermined distance to the core 200 by the pressure of the air in the bladder, so airflow to the outside through the core 200 is blocked. Further, since the plunger 600 is pressed to the first end of the 100 by the spring 500, the sealing member 700 can keep the exhaust port 130 closed. Accordingly, the air in the air bladder can be maintained at the predetermined pressure.

FIG. 4 is a view showing a state when the actuator has been operated to discharge the air in the air storage unit (air bladder).

As shown in FIG. 4, when air is not supplied through the intake nipple 210 of the core 200 and power is supplied to the coil 400, the solenoid valve starts the actuator, so the plunger 600 slides to the coil 200 due to an electromagnetic force by the coil 400. Accordingly, the sealing member 700 moves with the plunger 600 to the coil and the exhaust port 130 is opened, so the exhaust nipple 110 and the exhaust port 130 communicate with each other. Therefore, the air in the air bladder can be discharged through the exhaust port 130.

As described above, according to the pneumatic valve for a vehicle of one form of the present disclosure, it is possible to achieve intake/exhaust using one actuator, so it is to reduce the number of controllers for controlling the valve and simplify a control algorism. Further, it is possible to reduce the number and weight of parts for achieving the pneumatic valve for a vehicle and to reduce the size of the valve, so reduction in manufacturing cost can be expected.

FIG. 5 is an enlarged view of the portion indicated by ‘A’ in FIG. 1. The portion indicated by ‘A’ in FIG. 1 is the portion where the coupling part of the core 200 and the inner side of the valve housing 100 are in contact with each other.

As shown in FIG. 5, at least one protrusion 230 inclined upward toward the second end (right side in the figure) of the valve housing 100 may be formed around the coupling part of the core 200 disposed in the valve housing 100. Further, a groove 150 having a shape corresponding to the shape of the coupling part may be formed around the inner side of the valve housing 100, which are in contact with the coupling part of the core 200, to receive the protrusion 230. In particular, when the core 200 is coupled to the second end of the valve housing 100, the protrusion 230 is fitted in the groove 150, thereby the position of the core 200 is fixed. Further, resistance can be generated in airflow through the gap between the coupling part of the core 200 and the inner side of the valve 100 by the inclined structure.

Accordingly, by the coupling structure composed of the protrusion 230 and the groove 150, it is possible to achieve the pneumatic valve for a vehicle without a sealing member such as an O-ring that is used to hermetically coupling the core 200 in the related art. As described above, according to a pneumatic valve for a vehicle, it is possible to expect an effect of reducing the manufacturing cost by removing a sealing member, and it is also possible to secure the ability to operate an actuator of a solenoid valve by increasing the area where a magnetic force can be secured.

Although the present disclosure was described with reference to specific forms shown in the drawings, it is apparent to those skilled in the art that the present disclosure may be changed and modified in various ways without departing from the scope of the present disclosure.

What is claimed is:

1. A pneumatic valve for a vehicle, comprising:
a valve housing having a channel for air to flow therein and having a first end where an exhaust port configured to communicate with the channel and an exhaust nipple are formed;
a core fixed to a second end of the valve housing and configured to send air flowing inside from outside to the channel;
a check valve disposed at a first end of the core and configured to pass air flowing to the channel from the outside through the core, the check valve configured to block air flowing to the outside from the channel through the core;
a plunger disposed to face the first end of the core and configured to move through the channel; and
a sealing member disposed at a first end of the plunger and configured to open or close the exhaust port by moving with the plunger.

2. The pneumatic valve of claim 1, further comprising a coil disposed outside the valve housing and configured to slide the plunger using an electromagnetic force when power is supplied.

3. The pneumatic valve of claim 2, further comprising an elastic member disposed between the plunger and the core,
wherein the pneumatic valve is a normal close type in which the plunger is pressed to the first end of the valve housing by the elastic member, such that the sealing member keeps the exhaust port closed.

4. The pneumatic valve of claim 3, wherein when air with a predetermined pressure is supplied to a second end of the core and power is not supplied to the coil, the check valve is opened, air flows into the channel, the plunger is pressed to the first end of the valve housing by the elastic member, and the sealing member keeps the exhaust port closed, such that the air flowing in the channel is discharged to the outside through the exhaust nipple.

5. The pneumatic valve of claim 3, wherein the exhaust nipple is connected to an external air storage unit, and when air is not supplied to a second end of the core and power is not supplied to the coil, the check valve is blocked by pressure of the air in the air storage unit, airflow to the outside through the core from the channel is blocked, the plunger is pressed to the first end of the valve housing by the elastic member, and the sealing member keeps the exhaust port closed, such that the air in the air storage unit is kept therein.

6. The pneumatic valve of claim 3, wherein the exhaust nipple is connected to an external air storage unit, and when air is not supplied to a second end of the core and power is supplied to the coil, the plunger is slid to the coil by an electromagnetic force generated by the coil and the sealing member opens the exhaust port, such that the air in the air storage unit is discharged through the exhaust port.

7. The pneumatic valve of claim 1, wherein the core comprises: a coupling part disposed in the valve housing in contact with an inner side of the valve housing; and an intake nipple exposed toward the second end of the valve housing and connected to an air supply unit configured to supply air from the outside.

8. The pneumatic valve of claim 7, wherein a protrusion inclined upward toward the second end of the valve housing is formed around the coupling part, and a groove having a shape corresponding to a shape of the coupling part is formed around the inner side of the valve housing to receive the protrusion, the groove being in contact with the coupling part.

9. A pneumatic valve for a vehicle, comprising:
a valve housing having a channel for air to flow therein and having a first end where an exhaust port configured to communicate with the channel and an exhaust nipple are formed;
a core fixed to a second end of the valve housing and configured to send air flowing inside from outside to the channel;
a check valve disposed at a first end of the core and configured to pass air flowing to the channel from the outside through the core, the check valve configured to block air flowing to the outside from the channel through the core;
a plunger disposed to face the first end of the core and configured to move through the channel;
an elastic member disposed between the plunger and the core and configured to press the plunger to the first end of the valve housing;
a coil disposed outside the valve housing and configured to slide the plunger using an electromagnetic force when power is supplied; and
a sealing member disposed at a first end of the plunger and configured to open or close the exhaust port by moving with the plunger,
wherein when power is not supplied to the coil, the plunger is pressed to the first end of the valve housing by the elastic member and the sealing member keeps the exhaust port closed, and
when power is supplied to the coil, the plunger slides to the coil and the sealing member opens the exhaust port, such that the exhaust port and the exhaust nipple communicate with each other through the channel.
